(19) United States
(12) Patent Application Publication
(10) Pub. No.: US 2011/0190992 A1
(43) Pub. Date: Aug. 4, 2011

(54) METHOD FOR THE CONTROL OF AN AUTOMATIC TRANSMISSION OF A MOTOR VEHICLE, CONTROL DEVICE FOR AN AUTOMATIC TRANSMISSION OF A MOTOR VEHICLE AND MOTOR VEHICLE

(75) Inventor: Hans KLEILA, Russelsheim (DE)

(73) Assignee: GM GLOBAL TECHNOLOGY OPERATIONS LLC, Detroit, MI (US)

(21) Appl. No.: 13/020,145

(22) Filed: Feb. 3, 2011

(30) Foreign Application Priority Data
Feb. 3, 2010 (DE) 102010006643.5

(51) Int. Cl. F16H 59/66

(52) U.S. Cl. 701/58

(57) ABSTRACT

A method is provided for the control of an automatic transmission of a motor vehicle at least during downhill driving of the motor vehicle in coasting mode. The method includes, but is not limited to setting of a desired speed vₛₑₜ of the motor vehicle for a cruise control system of the motor vehicle, determining of a nominal acceleration aₛₑₜ of the motor vehicle and a current acceleration a_{actual} of the motor vehicle and comparing of the nominal acceleration aₛₑₜ with the current acceleration aₛₑₜ takes place. In addition, activating of a downhill driving mode of a control device of the automatic transmission if an_{actual} is ≧(aₛₑₜ+Δa) and determining of a first position of an accelerator pedal of the motor vehicle takes place. In addition, determining of a first current speed v_{actual-1} of the motor vehicle and comparing of the first current speed v_{actual-1} with the desired speed vₛₑₜ takes place. In addition, downshifting from the currently engaged gear of the automatic transmission into the next lower gear if v v_{actual-1} is ≧(vₛₑₜ+Δv) and if the determined first position of the accelerator pedal identifies a non-existent actuation of the accelerator pedal takes place.

### CROSS-REFERENCE TO RELATED APPLICATION

This application claims priority to German Patent Application No. 102010006643.5, filed Feb. 3, 2010, which is incorporated herein by reference in its entirety.

### TECHNICAL FIELD

The technical field relates to a method for the control of an automatic transmission of a motor vehicle, a control device for an automatic transmission of a motor vehicle, a motor vehicle with an automatic transmission, a program element and a machine-readable medium.

### BACKGROUND

From DE 102004024318A1 a downhill driving mode for a vehicle with an automatic transmission is known. Therein, within the framework of a method for detecting downhill driving and for operating the transmission of a motor vehicle in a downhill operating mode when downhill driving for a motor vehicle, comprising a continuously adjustable transmission, an automatic transmission or an automated manual shift transmission, downhill driving is detected if in coasting mode a speed increase is present, wherein in the downhill driving mode in coasting mode a downhill driving signal indicating downhill driving is formed, which is utilized by the driving strategy for calculating a desired transmission ratio for the transmission control. In an embodiment the downhill driving signal is incremented or multiplied by a factor when the vehicle in coasting mode accelerates and a cruise control system is switched on.

In view of the foregoing, at least one object is to state a method for the control of an automatic transmission of a motor vehicle at least during downhill driving of the motor vehicle in coasting mode, a control device for an automatic transmission of a motor vehicle, a motor vehicle with an automatic transmission and a control device for the automatic transmission, a program element and a machine-readable medium, which make possible a simple control of the automatic transmission at least during downhill driving of the motor vehicle in coasting mode, wherein additionally a set desired speed of the motor vehicle can be adjusted. In addition, other objects, desirable features and characteristics will become apparent from the subsequent summary and detailed description, and the appended claims, taken in conjunction with the accompanying drawings and this background.

### SUMMARY

In a first embodiment a method for the control of an automatic transmission of a motor vehicle at least during downhill driving of the motor vehicle in coasting mode is provided, wherein the method comprises the following steps. Setting of a desired speed vₛₑₜ of the motor vehicle for a cruise control system of the motor vehicle. In addition, determining of a nominal acceleration aₛₑₜ of the motor vehicle and a current acceleration a_{actual} of the motor vehicle. In addition, comparing of the nominal acceleration aₛₑₜ with the current acceleration a_{actual} and activating of a downhill driving mode of a control device of the automatic transmission takes place if a_{actual}≧(aₛₑₜ+Δa), wherein Δa is a predetermined value and wherein Δa>0. In addition, determining of a first position of an accelerator pedal of the motor vehicle takes place, wherein the first position of the accelerator pedal identifies a possible actuation of the accelerator pedal. In addition, determining of a first current speed v_{actual-1} of the motor vehicle and comparing of the first current speed v_{actual-1} with the desired speed vₛₑₜ takes place. In addition, automatic downshifting from the currently engaged gear of the automatic transmission into the next lower gear takes place, if v_{actual-1} is ≧(vₛₑₜ+Δv), wherein Δv is a predetermined value and wherein Δv is >0, and if the determined first position of the accelerator pedal identifies a non-existent actuation of the accelerator pedal.

This first embodiment of the method advantageously makes possible a simple control of the automatic transmission of the motor vehicle and automatic downshifting when operating the motor vehicle with automatic transmission with activated cruise control system at least during downhill driving of the motor vehicle in coasting mode. Because of this, automatic downshifting during downhill driving of the motor vehicle on exceeding of the desired speed vₛₑₜ by a predetermined value Δv is made possible in order to adjust the target speed in form of the desired speed vₛₑₜ. This results in an improvement of the drivability of the motor vehicle, particularly with activated cruise control system.

In a further embodiment of the method the method comprises the following steps following the automatic downshift. Determining of a second position of the accelerator pedal takes place, wherein the second position of the accelerator pedal identifies a possible actuation of the accelerator pedal. In addition, determining of a second current speed v_{actual-2} of the motor vehicle and comparing of the second current speed v_{actual-2} with the desired speed vₛₑₜ takes place. In addition, automatic downshifting from the currently engaged gear of the automatic transmission into the next lower gear takes place if v_{actual-2} is ≧(vₛₑₜ+Δv) and if the determined second position of the accelerator pedal identifies a non-existent actuation of the accelerator pedal. This embodiment of the method advantageously makes possible a further automatic downshifting in the event that the target speed in form of the desired speed vₛₑₜ following completed first automatic downshifting is not yet fully adjusted. The mentioned steps of this embodiment can also be carried out more than once in order to perform at least one further automatic downshift if applicable from the currently engaged gear of the automatic transmission into the next lower gear for adjusting the desired speed vₛₑₜ.

Determining the first position of the accelerator pedal and/or determining the second position of the accelerator pedal in a preferred development of the method includes determining a pressing-down degree of the accelerator pedal, particularly preferred with respect to the maximum possible pressing-down degree of the accelerator pedal. Automatic downshifting from the currently engaged gear of the automatic transmission into the next lower gear in this development takes place if v_{actual-2} is ≧(vₛₑₜ+Δv) and if the pressing-down degree amounts to 0% or 0° or if v_{actual-2} is ≧(vₛₑₜ+Δv) and if the pressing-down degree amounts to 0% or 0°.

In a further development of the method the predetermined value of Δv is set as a function of the mass of the motor vehicle. Because of this, the mass of the motor vehicle can be advantageously taken into account with the determining and setting of the value of Δv and the automatic downshifting for motor vehicles with different masses take place at different values of Δv.

In a further development of the method the predetermined value of Δa is set as a function of the mass of the motor vehicle. This makes possible activating the downhill driving mode as a function of the mass of the motor vehicle and thus adapted activating with motor vehicles having different masses.

In a further embodiment of the method the nominal acceleration aₛₑₜ of the motor vehicle is determined making use of at least one predetermined nominal state of the motor vehicle and of at least one predetermined nominal state of a road surface. The at least one predetermined nominal state of the road surface preferably includes a level road surface and/or a dry road surface. The at least one predetermined nominal state of the motor vehicle preferably includes one single occupant of the motor vehicle and/or predetermined loading of the motor vehicle. The mentioned embodiments have the advantage that the nominal acceleration aₛₑₜ of the motor vehicle can be determined in a simple manner.

In an embodiment of the method a current driving resistance Factual of the motor vehicle is additionally determined and the downhill driving mode activated if a_{actual} is ≧(aₛₑₜ+Δa) and if Factual is ≦F0, wherein F0 is a predetermined value.

In a further embodiment of the method a current angle of inclination α_{actual} of the motor vehicle in a longitudinal direction of the motor vehicle is additionally determined and the downhill driving mode activated if a_{actual} is ≧(aₛₑₜ+Δa) and if α_{actual} is ≧α0, wherein α0 is a predetermined value.

In a further embodiment the method additionally comprises the following steps. Determining of a current position of the motor vehicle and determining of data of a road surface driven over by the motor vehicle takes place in the region of the determined position of the motor vehicle by means of map data stored in a storage device. In addition, activating of the downhill driving mode takes place if a_{actual} is ≧(aₛₑₜ+Δa) and if the determined data of the road surface identifies a downhill gradient above a predetermined threshold value of the road surface in the region of the determined position of the motor vehicle.

The three last mentioned embodiments have the advantage that for detecting a downhill driving of the motor vehicle in addition to the comparison of the nominal acceleration aₛₑₜ with the current acceleration a_{actual} at least one further parameter is determined and compared with a predetermined value. Thus, in addition to the condition a_{actual} is ≧(aₛₑₜ+Δa) at least one further condition applies in order to activate the downhill driving mode. Because of this, downhill driving of the motor vehicle can be detected to a further improved degree and the downhill driving mode correspondingly activated only in these cases.

In a further development the method after activating the downhill driving mode comprises the following steps. Determining of a position of a brake pedal of the motor vehicle takes place, wherein the position of the brake pedal identifies a possible actuation of the brake pedal. In addition, deactivating of the downhill driving mode takes place if the determined position of the brake pedal identifies an actuation of the brake pedal. This development advantageously makes possible to reliably deactivate the downhill driving mode if the brake pedal is actuated. In such a situation the requirement of the driver of the motor vehicle typically does not consist in reaching the desired speed but for example in bringing about intensified braking down of the motor vehicle. Thus, deactivating of the downhill driving mode is desirable in such situations.

The application furthermore relates to a control device for an automatic transmission of a motor vehicle, wherein the control device comprises a first determination unit designed to determine a nominal acceleration aₛₑₜ of the motor vehicle and a current acceleration a_{actual} of the motor vehicle, and a first comparison unit, designed for comparing the nominal acceleration aₛₑₜ with the current acceleration a_{actual}. In addition, the control device comprises an activation unit designed for activating a downhill driving mode of the control device, if a_{actual} is ≧(aₛₑₜ+Δa), wherein Δa is a predetermined value and wherein Δa>0, and a second determination unit designed for determining a first position of an accelerator pedal of the motor vehicle, wherein the first position of the accelerator pedal identifies a possible actuation of the accelerator pedal. In addition, the control device comprises a second comparison unit, designed for comparing a first determined current speed vactual,1 of the motor vehicle with a set desired speed vₛₑₜ of the motor vehicle and a shifting unit for the automatic downshifting from the currently engaged gear of the automatic transmission into the next lower gear if v_{actual-1} is ≧(vₛₑₜ+Δv), wherein Δv is a predetermined value and wherein Δv is >0, and if the determined first position of the accelerator pedal identifies a non-existent actuation of the accelerator pedal.

The embodiments additionally relate to a motor vehicle comprising a cruise control system, an automatic transmission and a control device for the automatic transmission, wherein the control device is designed according to the embodiment just mentioned. The control device and the motor vehicle have the advantages already mentioned in connection with the first embodiment of the method which at this point are not mentioned again to avoid repetitions.

The embodiments additionally relates to a program element which, when it is executed on a processor of a control device for an automatic transmission of a motor vehicle, prompts the control device to execute the following steps. The control device is prompted to execute determining of a nominal acceleration aₛₑₜ of the motor vehicle and a current acceleration a_{actual} of the motor vehicle by means of a first determination unit and comparing of the nominal acceleration aₛₑₜ with the current acceleration a_{actual} by means of a first comparison unit. In addition, the control device is prompted to execute activating a downhill driving mode of the control device by means of an activation unit if a_{actual} is ≧(a ₛₑₜ+Δa), wherein Δa is a predetermined value and wherein Δa is >0. In addition, the control device is prompted to execute determining of a first position of an accelerator pedal of the motor vehicle by means of a second determination unit, wherein the first position of the accelerator pedal identifies a possible actuation of the accelerator pedal, and comparing of a first determined current speed v_{actual-1} of the motor vehicle with a set desired speed vₛₑₜ of the motor vehicle by means of a second comparison unit. In addition to this, the control device is prompted to execute automatic downshifting from the currently engaged gear of the automatic transmission to the next lower gear by means of a shifting unit, if v_{actual-1} is ≧(vₛₑₜ+Δv), wherein Δv is a predetermined value and wherein Δv is >0, and if the determined first position of the accelerator pedal identifies a non-existent actuation of the accelerator pedal.

The embodiments additionally relate to a machine-readable medium on which a program element according to the embodiment just mentioned is stored. The program element and the machine-readable medium have the advantages already mentioned in connection with the first embodiment of the method, which are not mentioned again at this point to avoid repetitions.

### BRIEF DESCRIPTION OF THE DRAWINGS

The present invention will hereinafter be described in conjunction with the following drawing figures, wherein like numerals denote like elements, and

FIG. 1 shows a flow diagram of a method for the control of an automatic transmission of a motor vehicle at least during downhill driving of the motor vehicle in coasting mode according to an embodiment;

FIG. 2 shows a motor vehicle with a control device for an automatic transmission of the motor vehicle according to an embodiment; and

FIG. 3 shows the control device for the automatic transmission of the motor vehicle according to FIG. 2.

### DETAILED DESCRIPTION

The following detailed description is merely exemplary in nature and is not intended to limit the application and uses. Furthermore, there is no intention to be bound by any theory presented in the preceding background of the invention or the following detailed description.

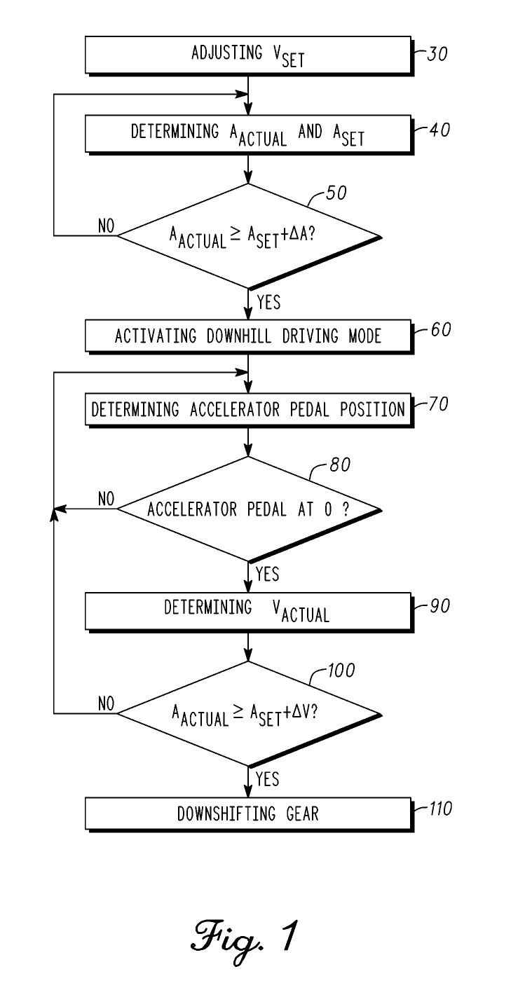

FIG. 1 shows a method for the control of an automatic transmission of a motor vehicle at least during downhill driving of the motor vehicle in coasting mode according to an embodiment. Here, setting of a desired speed of vₛₑₜ of the motor vehicle for a cruise control system of the motor vehicle is affected in a step 30 and determining a nominal acceleration aₛₑₜ of the motor vehicle and a current acceleration a_{actual} of the motor vehicle in a step 40. In a step 50, comparing of the nominal acceleration aₛₑₜ with the current acceleration a_{actual} takes place. In the embodiment shown, this is affected in that it is determined if the relationship a_{actual}≧(aₛₑₜ+Δa) is applicable, wherein Δa is a predetermined value and wherein Δa is >0.

If this relationship is not applicable, the step 40 is performed repeatedly. If the relationship is satisfied, activating of a downhill driving mode of a control device of the automatic transmission takes place in a step 60. With activated downhill driving mode, determining of a position of an accelerator pedal of the motor vehicle takes place in a step 70, wherein the position of the accelerator pedal identifies a possible actuation of the accelerator pedal. In the shown embodiment this is affected through determining of the pressing-down degree of the accelerator pedal. During this, an absolute value of the pressing-down degree, for example in degrees, or a relative value of the pressing-down degree, for example relative to the maximum possible pressing-down degree of the accelerator pedal can be determined.

In a step 80 it is determined if the accelerator pedal is not actuated. In the shown embodiment it is determined to this end if the pressing-down degree amounts to 0% of the maximum possible pressing-down degree or 0°.

If the pressing-down degree is distinct from 0, the step 70 is performed repeatedly. If the pressing-down degree is 0% or 0°, determining of a current speed v_{actual} of the motor vehicle takes place in a step 90. In a step 100, comparing of the current speed v_{actual} with the desired speed vₛₑₜ takes place. In the embodiment shown, this is affected in that it is determined if the relationship v_{actual}≧(vₛₑₜ+Δv) is applicable, wherein Δv is a predetermined value and wherein Δv is >0. If this relationship is not satisfied, the steps 70, 80 and, if applicable, 90 are performed repeatedly.

If the relationship is satisfied, automatic downshifting from the currently engaged gear of the automatic transmission into the next lower gear takes place in a step 110.

Determining the current speed v_{actual} and comparing the current speed v_{actual} with the desired speed vₛₑₜ in this case can also take place prior to determining the position of the accelerator pedal and comparing of the pressing-down degree of the accelerator pedal, that is the steps 90 and 100 can be executed before the steps 70 and 80.

The shown embodiment of the method advantageously makes possible automatic downshifting during operation of the cruise control system with the motor vehicle having an automatic transmission during downhill driving in coasting mode upon acceleration increase in order to adjust the target speed in form of the desired speed vₛₑₜ. This results in an improvement of the drivability of the motor vehicle with automatic transmission and cruise control system.

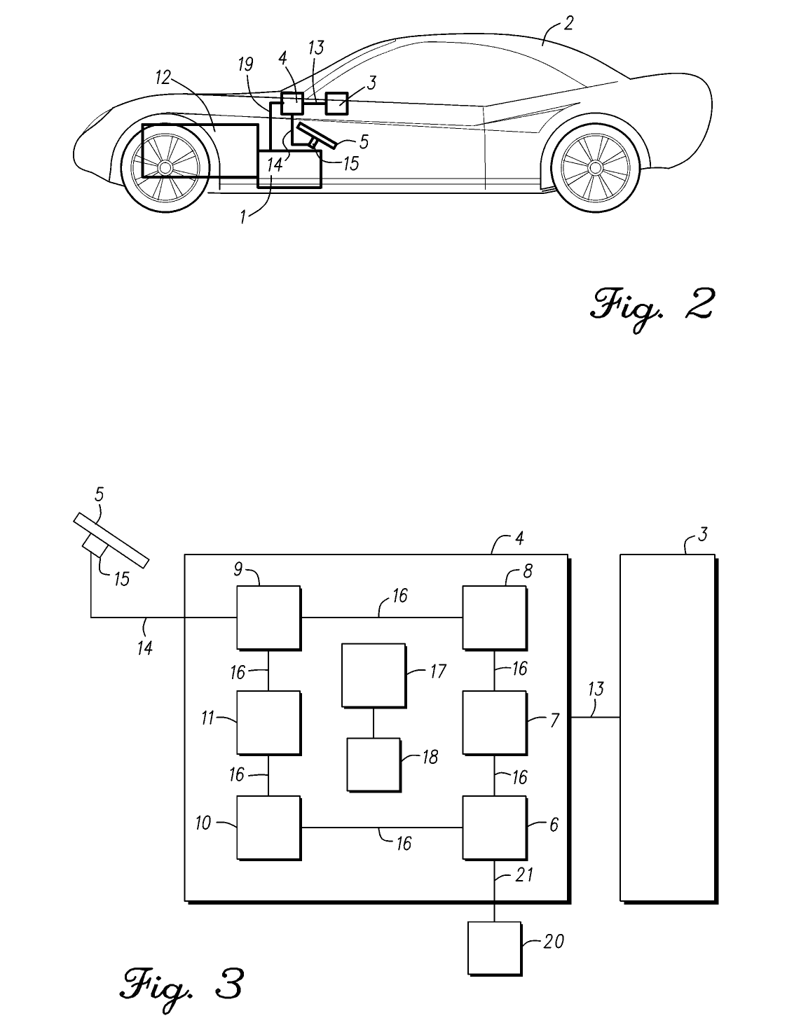

FIG. 2 shows a motor vehicle 2 according to an embodiment. The motor vehicle 2 comprises a schematically represented automatic transmission 1, which is coupled to an engine 12 of the motor vehicle 2. Furthermore, the automatic transmission 1 is connected to a control device 4 for the automatic transmission 1 via a control and signal line 19. The motor vehicle 2 additionally comprises a cruise control system 3. The cruise control system 3 is connected to the control device 4 for the automatic transmission 1 via a signal line 13.

In addition, the motor vehicle 2 comprises an accelerator pedal 5 and a sensor 15. The sensor 15 is designed for determining a position of the accelerator pedal 5, wherein the position of the accelerator pedal 5 identifies a possible actuation of the accelerator pedal 5. For example, the sensor 15 is designed for determining the pressing-down degree of the accelerator pedal 5. By way of a signal line 14 the determined position of the accelerator pedal 5 is transmitted from the sensor 15 to the control device 4. Further details of the control device 4 are explained in more detail in connection with the following figure.

FIG. 3 shows the control device 4 for the automatic transmission of the motor vehicle according to FIG. 2 not shown in more detail in FIG. 3. Components with the same functions as in FIG. 2 are marked with the same reference characters and are not discussed in more detail in the following. The control device 4 comprises a first determination unit 6 which is designed for determining a nominal acceleration aₛₑₜ of the motor vehicle and a current acceleration a_{actual} of the motor vehicle. The nominal acceleration aₛₑₜ in this case is preferably determined using at least one predetermined nominal state of the motor vehicle and at least one predetermined nominal state of a road surface. Particularly preferred, the at least one predetermined nominal state of the road surface includes a level road surface and the at least one predetermined nominal state of the motor vehicle a single occupant of the vehicle. To determine the current acceleration a_{actual} of the motor vehicle the determination unit 6 in the embodiment shown is connected to a sensor 20 via a signal line 21, which sensor determines and transmits the current speed of the motor vehicle via the signal line 21 to the determination unit 6. From the change in time of the current speed the first determination unit 6 determines the current acceleration a_{actual} of the motor vehicle.

Furthermore, the control device 4 comprises a first comparison unit 7 that is designed for comparing the nominal acceleration aₛₑₜ with the current acceleration a_{actual}. In addition, the control device 4 comprises an activation unit 8 that is designed for activating a downhill driving mode of the control device 4, if a_{actual} is ≧(aₛₑₜ+Δa), wherein Δa is a predetermined value and wherein Δa is >0.

The control device 4 additionally comprises a second determination unit 9 which is designed for determining a position of the accelerator pedal 5 of the motor vehicle, wherein the position of the accelerator pedal 5 identifies a possible actuation of the accelerator pedal 5. To this end, the second determination unit 9 is connected to the sensor 15 via the signal line 14, which sensor for example determines the pressing-down degree of the accelerator pedal 5. The control device 4 additionally comprises a second comparison unit 10 which is designed for comparing a current speed v_{actual} of the motor vehicle determined by means of the sensor 20 with a set desired speed vₛₑₜ of the motor vehicle. The desired speed vₛₑₜ of the motor vehicle in the shown embodiment in this case is set by means of the cruise control system 3 of the motor vehicle and transmitted to the control device 4 via the signal line 13.

In addition, the control device 4 comprises a shifting unit 11 which is designed for the automatic downshifting from the currently engaged gear of the automatic transmission into the next lower gear if v_{actual} is ≧(vₛₑₜ+Δv), wherein Δv is a predetermined value and wherein Δv is >0, and if the determined position of the accelerator pedal 5 identifies a non-existent actuation of the accelerator pedal 5. The first determination unit 6, the first comparison unit 7, the activation unit 8, the second determination unit 9, the second comparison unit 10 and the shifting unit 11 are interconnected via connecting lines 16.

In the shown embodiment, the control device 4 comprises a processor 17 and a machine-readable medium 18, wherein on the machine-readable medium 18 a program element is stored, which, if it is executed on the processor 17 of the control device 4 for the automatic transmission of the motor vehicle, prompts the control device 4 to execute the mentioned steps by means of the mentioned units of the control device 4. To this end, the processor 17 is directly or indirectly connected in a manner not shown in more detail to the first determination unit 6, the first comparison unit 7, the activation unit 8, the second determination unit 9, the second comparison unit 10 and the shifting unit 11.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for control of an automatic transmission of a motor vehicle at least during downhill driving of the motor vehicle in a coasting mode, comprising:
setting a desired speed vₛₑₜ of the motor vehicle for a cruise control system of the motor vehicle;
determining a nominal acceleration aₛₑₜ of the motor vehicle and a current acceleration a_{actual} of the motor vehicle;
comparing the nominal acceleration aₛₑₜ with the current acceleration a_{actual};
activating a downhill driving mode of a control device of the automatic transmission if a_{actual} is ≧(aₛₑₜ+Δa), where Δa is a predetermined value and Δa>0;
determining a first position of an accelerator pedal of the motor vehicle, the first position indicative of a possible actuation of the accelerator pedal;
determining a first current speed v_{actual-1} of the motor vehicle;
comparing the first current speed v_{actual-1} with the desired speed vₛₑₜ; and
downshifting from a currently engaged gear of the automatic transmission into a next lower gear if v_{actual-1} is ≧(vₛₑₜ+Δv), where Δv is a predetermined value and Δv is >0, and if the first position of the accelerator pedal identifies a non-existent actuation of the accelerator pedal.

2. The method according to claim 1, further comprising:
determining a second position of the accelerator pedal that is indicative of a second possible actuation of the accelerator pedal;
determining a second current speed v_{actual-2} of the motor vehicle;
comparing the second current speed v_{actual-2} with the desired speed vₛₑₜ,
downshifting from the currently engaged gear of the automatic transmission into the next lower gear if v_{actual-2} is ≧(vₛₑₜ+Δv) and if the second position of the accelerator pedal identifies the non-existent actuation of the accelerator pedal.

3. The method according to claim 1, wherein the predetermined value of Δv is set as a function of a mass of the motor vehicle.

4. The method according to claim 1, wherein the predetermined value of Δa is set as a function of a mass of the motor vehicle.

5. The method according to claim 1, wherein the nominal acceleration aₛₑₜ of the motor vehicle is determined subject to use of at least one predetermined nominal state of the motor vehicle and of the at least one predetermined nominal state of a road surface.

6. The method according to claim 5, wherein the at least one predetermined nominal state of the road surface includes a level road surface.

7. The method according to claim 5, wherein the at least one predetermined nominal state of the motor vehicle comprises a single occupant of the motor vehicle.

8. The method according to claim 1, wherein additionally a current driving resistance F_{actual} of the motor vehicle) is determined and wherein the downhill driving mode is activated if a_{actual} is ≧(aₛₑₜ+Δa) and if F_{actual} is ≦F0, where F0 is a predetermined value.

9. The method according to claim 1, wherein a current angle of inclination α_{actual} of the motor vehicle is in a longitudinal direction of the motor vehicle and the downhill driving mode is activated if a_{actual} is ≧(aₛₑₜ+Δa) and if α_{actual} is >α0, where α0 is a predetermined value.

10. The method according to claim 1, further comprising:
determining a current position of the motor vehicle;
determining data of a road surface driven over by the motor vehicle in a region of a position of the motor vehicle with a map data stored in a storage device;
activating the downhill driving mode, if a_{actual} is ≧(aₛₑₜ+Δa) and if the data of a road surface identifies a downhill gradient of the road surface located above a predetermined threshold value in the region of the position of the motor vehicle.

11. The method according to claim 1, further comprising:
determining a position of a brake pedal of the motor vehicle, where the position of the brake pedal is indicative of a possible brake actuation of the brake pedal; and
deactivating the downhill driving mode if the position of the brake pedal identifies an actuation of the brake pedal.

12. A control device for an automatic transmission of a motor vehicle, comprising:
a first determination unit adapted to determine a nominal acceleration aₛₑₜ of the motor vehicle and a current acceleration a_{actual} of the motor vehicle;
a first comparison unit adapted to compare the nominal acceleration aₛₑₜ with the current acceleration a_{actual};
an activation unit adapted to activate a downhill driving mode of the control device if a_{actual} is ≧(aₛₑₜ+Δa), where Δa is a predetermined value and wherein Δa is >0;
a second determination unit adapted to determine a first position of an accelerator pedal of the motor vehicle, where the first position of the accelerator pedal is indicative of a possible actuation of the accelerator pedal;
a second comparison unit adapted to compare a first determined current speed v_{actual-1} of the motor vehicle with a set desired speed vₛₑₜ of the motor vehicle;
a shifting unit adapted to downshift from a currently engaged gear of the automatic transmission into a next lower gear if v_{actual-1} is ≧(vₛₑₜ+Δv), where Δv is a predetermined value and wherein Δv is >0, and if the first position of the accelerator pedal identifies a non-existent actuation of the accelerator pedal.

13. The control device according to claim 12, further comprising:
a third determination unit adapted to determine a second position of the accelerator pedal that is indicative of a second possible actuation of the accelerator pedal;
a fourth determination unit adapted to determine a second current speed v_{actual-2} of the motor vehicle; and
a third comparison unit adapted to compare the second current speed v_{actual-2} with the desired speed vₛₑₜ,
wherein the shifting unit is adapted to downshift from the currently engaged gear of the automatic transmission into the next lower gear if v_{actual-2} is ≧(vₛₑₜ+Δv) and if the second position of the accelerator pedal identifies the non-existent actuation of the accelerator pedal.

14. The control device according to claim 12, wherein the predetermined value of Δv is set as a function of a mass of the motor vehicle.

15. The control device according to claim 12, wherein the predetermined value of Δa is set as a function of a mass of the motor vehicle.

16. The control device according to claim 12, wherein the nominal acceleration aₛₑₜ of the motor vehicle is determined subject to use of at least one predetermined nominal state of the motor vehicle and of the at least one predetermined nominal state of a road surface.

17. The control device according to claim 15, wherein at least one predetermined nominal state of a road surface includes a level road surface.

18. The control device according to claim 17, wherein the at least one predetermined nominal state of the motor vehicle comprises a single occupant of the motor vehicle.

19. The control device according to claim 12, wherein additionally a current driving resistance F_{actual} of the motor vehicle) is determined and wherein the downhill driving mode is activated if a_{actual} is ≧(aₛₑₜ+Δa) and if F_{actual} is ≦F0, where F0 is a predetermined value.

20. A computer readable medium embodying a computer program product, said computer program product comprising:
a program for controlling of an automatic transmission of a motor vehicle, the program configured to:
determine a nominal acceleration aₛₑₜ of the motor vehicle and a current acceleration a_{actual} of the motor vehicle with a first determination unit;
compare the nominal acceleration aₛₑₜ with the current acceleration a_{actual} by means of a first comparison unit;
activate a downhill driving mode of a control device with an activation unit if a_{actual} is ≧(aₛₑₜ+Δa), where Δa is a predetermined value and wherein Δa is >0;
determine a first position of an accelerator pedal of the motor vehicle with a second determination unit, where the first position of the accelerator pedal identifies a possible actuation of the accelerator pedal;
compare a first determined current speed v_{actual-1} of the motor vehicle with a set desired speed vₛₑₜ of the motor vehicle with a second comparison unit; and
initiate a downshift from a currently engaged gear of the automatic transmission into a next lower gear with a shifting unit, if v_{actual-1} is ≧(vₛₑₜ+Δv), where Δv is a predetermined value and wherein Δv is >0, and if the first position of the accelerator pedal identifies a non-existent actuation of the accelerator pedal.
